(19) United States
(12) Patent Application Publication
(10) Pub. No.: US 2006/0005007 A1
(43) Pub. Date: Jan. 5, 2006

(54) System, method and computer program product for authenticating a data source in multicast communications

(75) Inventor: Atul Sharma, Westford, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/867,150

(22) Filed: Jun. 14, 2004

(51) Int. Cl. H04L 9/00

(52) U.S. Cl. 713/153

(57) ABSTRACT

A system is provided for multicasting a data packet in a multicast group. The system includes a source member and a plurality of destination members. The source member is capable of generating a code for the data packet using a symmetric key associated with the source member, and thereafter multicasting the data packet and the code. Each of the destination members is capable of receiving the data packet and the code. The destination member can then multicast a recall packet to the members of the multicast group when the destination member determines that the source member claims an identity of the respective destination member (i.e., spoofs the identity of the respective destination member). Otherwise, the destination member is capable of authenticating the source member based upon the code.

### FIELD OF THE INVENTION

The present invention generally relates to systems and methods of providing multicast security and, more particularly, relates to systems and methods of providing data source authentication in multicast security.

### BACKGROUND OF THE INVENTION

Multimedia streaming is considered to be a major evolving Internet application since it aims at replacing widely known television applications such as video-on-demand, pay-per-view, or video broadcast. Currently, a number of portal sites offer Internet protocol (IP) multicast services to be extended to the communication of such services to wireless terminals. With such a service, a wireless system broadcasts data packets to a plurality of wireless terminals. Each wireless terminal receives and processes the same stream of packets. An example of a multicast service is IP multicast streaming for news and entertainment content in audio and video formats. As will be appreciated, multicast communication is typically more spectrum efficient than unicast communication since multicast communication services are amenable to broadcasting to a group of wireless terminals. Because frequency spectrum for wireless services is very limited and very expensive to expand, the utilization of multicast services is very appealing to wireless service providers.

With an increase in the use of multicast communication, providing security for such communication also increases. Generally, multicast security has a number of goals, including for example, securing multicast communication for the multicast group (e.g., encryption), integrity protection, and providing an automated exchange and management of keying material for the multicast group. In addition, multicast security often attempts to deploy one or more security policies for multicast communications within the multicast group.

Multicast security also typically desires to provide data source authentication, often in addition to securing multicast communication for the multicast group. As will be appreciated, a source of data is often automatically authenticated in the case of in point-to-point communications. This is particularly the case when such point-to-point communications are symmetric key secured since only the source and destination possess the symmetric keys necessary to decrypt and/or authenticate the transmitted content. In contrast, in many conventional multicast security techniques, all of the members of a multicast group possess a symmetric key common to the group members. In such an instance, the source of data can typically only be identified as being a member of the multicast group, without identifying the particular group member.

One conventional technique for authenticating the data source in multicast communications is to digitally sign each data packet transmitted from the source to the members of the multicast group. Digital signatures provide non-repudiation on top of data source authentication and integrity protection. However, digital signatures also typically utilize public-key cryptography, which can be significantly slower to implement than symmetric key cryptography message authentication codes (MACs). Digital signatures also often require more data space overhead than MACs.

In an effort to alleviate the overhead associated with digital signatures, techniques have been developed whereby digital signatures are amortized over number of packets. Examples of such techniques are star/hashing techniques, and different variations of hash chaining. Whereas such amortization techniques do reduce the overhead associated with digital signatures, such techniques also typically increase the communication costs, and often require the source and destinations to buffer data. In addition, various techniques such as that provided by the Timed Efficient Stream Loss-Tolerant Authentication (TESLA) protocol and its variations can require a form of time synchronization between the source and destinations, further complicating the source authentication procedure.

### SUMMARY OF THE INVENTION

In light of the foregoing background, embodiments of the present invention provide an improved system, method and computer program product for multicasting data packets and authenticating the source of the data packets. In accordance with embodiments of the present invention, a multicast group includes a source member multicasting data packets and a plurality of destination members receiving the data packets. In contrast to conventional multicast security techniques, the destination members of embodiments of the present invention are capable of authenticating the source member without requiring digital signatures or time synchronization between the source and destinations in point-to-multipoint, multicast communication. Briefly, as explained below, each member of a multicast group can be associated with a symmetric key that is known to each other member of the multicast group. To permit the source member to multicast data packets to the destination members, and allow the destination members to authenticate the source member of the data packets, the source member can multicast the data packet, and a code generated with the symmetric key associated with the source member. The destination members can then authenticate the source member based upon the data packet, code and the symmetric key associated with the source member.

By utilizing symmetric key associated with the source member, and authenticating the source member based upon its symmetric key, the destination clients of embodiments of the present invention are capable of authenticating the source member against communications outside the multicast group. To further authenticate the source member against communications within the multicast group, that is to deter one member of the group from spoofing the identity of another member, each member of the multicast group can be configured to multicast a “recall” packet to the multicast group when the member receives a data packet purported to be from itself, which the member did not multicast to the group.

According to one aspect of the present invention, a system is provided for multicasting a data packet in a multicast group. The system includes a source member and a plurality of destination members. The source member is capable of generating a code, such as a message authentication code (MAC), for the data packet using a symmetric key associated with the source member. The source member can also be capable of encrypting the data packet such that the encrypted data packet can thereafter be multicast. Then, the source member can multicast the data packet, the code and, if so desired, a member identifier.

Each of the destination members is capable of receiving the data packet and the code. Each destination member can then multicast a recall packet to the members of the multicast group when the destination member determines that the source member claims an identity of the respective destination member (i.e., spoofs the identity of the respective destination member). For example, each destination member can be capable of comparing the member identifier in the content packet to a member identifier associated with the destination member. And when the comparison identifies a match, the destination member can multicast the recall packet to the multicast group. Before sending the recall packet, however, the destination member can be capable of digitally signing the recall packet using a private key of a public/private key pair associated with the destination member. In such instances, the destination member can multicast the digitally signed recall packet such that the members of the multicast group can authenticate the recall packet using the public key of the public/private key pair.

If a destination member determines that the source member does not claim the identity of the respective destination member, however, the destination member is capable of authenticating the source member based upon the code. The destination member can be capable of authenticating the source member by authenticating the code using the data packet and the symmetric key associated with the source member. For example, when the code comprises a MAC, the destination member is capable of authenticating the code by generating a comparison MAC at the destination member based upon the data packet and the symmetric key associated with the source member. Thereafter, the destination member can compare the comparison MAC with the received MAC such that the source member is authenticated when the comparison identifies a match between the comparison MAC and the received MAC.

If the source member is authenticated by a destination member, the destination member can be capable of decrypting the encrypted data packet when the source member multicasts an encrypted data packet. Likewise, the destination member can be capable of storing the data packet in a temporary data queue of a data store for a wait period. Then, if the destination member receives a recall packet within the wait period, the destination member can be capable of dropping the data packet from the data queue. Otherwise, the destination member can move the data packet from the temporary data queue after the wait period.

According to other aspects of the present invention, a destination member, method and computer program product are provided for authenticating a source member of a multicast group including a plurality of members. Embodiments of the present invention therefore provide an improved system, destination member, method and computer program product for multicasting data packets and authenticating a source member of a multicast group. In contrast to conventional multicast security techniques, in accordance with embodiments of the present invention, the destination members are capable of authenticating the source member without requiring digital signatures or time synchronization between the source and destinations in point-to-multipoint, multicast communication. In this regard, the destination members can authenticate the source member based upon a code generated using the data packet and a symmetric key associated with the source member. Further, to further authenticate the source member against communications within the multicast group, each destination member can be configured to multicast a “recall” packet to the multicast group when the member receives a data packet purported to be from itself, which the member did not multicast to the group. As such, the system, destination member, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one type of terminal and system that would benefit from embodiments of the present invention;

FIG. 2 is a schematic block diagram of an entity capable of operating as a terminal, origin server and/or user processor, in accordance with embodiments of the present invention;

FIG. 3 is a schematic block diagram of a terminal, in accordance with one embodiment of the present invention;

FIG. 4A is a functional block diagram of a source member multicasting a data packet to destination members of a multicast group, in accordance with one embodiment of the present invention;

FIG. 4B is a functional block diagram of a destination member multicasting a recall packet to other members of a multicast group in response to the destination member receiving a content packet identifying itself as the source member;

FIG. 5 is a flowchart including various steps in a method of multicasting one or more data packets to a multicast group, in accordance with one embodiment of the present invention;

FIG. 6 is a schematic illustration of an example content packet, in accordance with one embodiment of the present invention;

FIGS. 7A, 7B and 7C are flowcharts including various steps in a method of authenticating a source member multicasting data packets to a multicast group including the source member and a plurality of destination members, in accordance with one embodiment of the present invention; and

FIG. 8 is a schematic illustration of an example recall packet, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

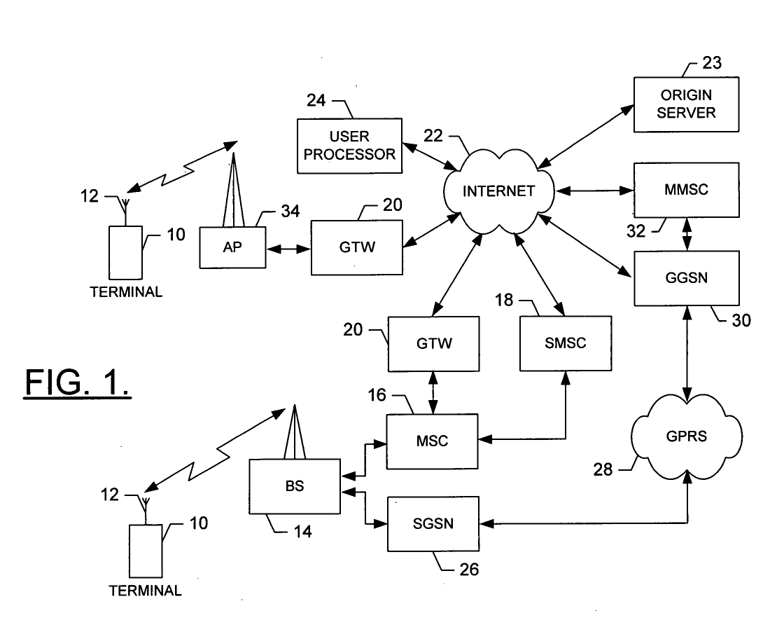

Referring to FIG. 1, an illustration of one type of system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, the system can include a terminal 10 that may have an antenna 12 for transmitting signals to and for receiving signals from a base site or base station (BS) 14. The base station is a part of one or more cellular or mobile networks that each include elements required to operate the network, such as a mobile switching center (MSC) 16. As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also control the forwarding of messages for the terminal to and from a messaging center, such as short messaging service (SMS) messages to and from a SMS center (SMSC) 18.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 20, and the GTW is coupled to a WAN, such as the Internet 22. In turn, devices such as processing elements (e.g., personal computers, server computers or the like) can be coupled to the terminal 10 via the Internet. For example, as explained below, the processing elements can include one or more processing elements associated with one or more origin servers 23, user processors 24, or the like, one of each being illustrated in FIG. 1 and described below.

The BS 14 can also be coupled to a signaling GPRS (General Packet Radio Service) support node (SGSN) 26. As known to those skilled in the art, the SGSN is typically capable of performing functions similar to the MSC 16 for packet switched services. The SGSN, like the MSC, can be coupled to a data network, such as the Internet 22. The SGSN can be directly coupled to the data network. In a more typical embodiment, however, the SGSN is coupled to a packet-switched core network, such as a GPRS core network 28. The packet-switched core network is then coupled to another GTW, such as a GTW GPRS support node (GGSN) 30, and the GGSN is coupled to the Internet. In addition to the GGSN, the packet-switched core network can also be coupled to a GTW 20. Also, the GGSN can be coupled to a messaging center, such as a multimedia messaging service (MMS) center 32. In this regard, the GGSN and the SGSN, like the MSC, can be capable of controlling the forwarding of messages, such as MMS messages. The GGSN and SGSN can also be capable of controlling the forwarding of messages for the terminal to and from the messaging center.

By coupling the SGSN 24 to the GPRS core network 26 and the GGSN 28, devices such as service providers 22 can be coupled to the terminal 10 via the Internet 20, SGSN and GGSN. In this regard, devices such as service providers can communicate with the terminal across the SGSN, GPRS and GGSN. In addition, by coupling the SGSN 26 to the GPRS core network 28 and the GGSN 30, devices such as an origin server 23 and/or user processor 24 can be coupled to the terminal 10 via the Internet 22, SGSN and GGSN. In this regard, devices such as an origin server and/or user processor can communicate with the terminal across the SGSN, GPRS and GGSN. By directly or indirectly connecting the terminals and the other devices (e.g., origin server, user processor, etc.) to the Internet, the terminals and other devices can communicate with one another, such as in accordance with a multicast communication technique like the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

Although not every element of every possible network is shown and described herein, it should be appreciated that the terminal 10 can be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. Additionally or alternatively, mobile network(s) can be capable of supporting communication in accordance with any one or more of a number of different digital broadcast networks, such as Digital Video Broadcasting (DVB) networks including DVB-T (DVB-Terrestrial) and/or DVB-H (DVB-Handheld), Integrated Services Digital Broadcasting (ISDB) networks including ISDB-T (ISDB-Terrestrial), or the like.

More particularly, for example, the terminal 10 can be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode terminals (e.g., digital/analog or TDMA/CDMA/analog phones).

The terminal 10 can further be coupled to one or more wireless access points (APs) 34. The APs can be configured to communicate with the terminal in accordance with techniques such as, for example, radio frequency (RF), Bluetooth (BT), infrared (IrDA) or any of a number of different wireless networking techniques, including WLAN techniques. The APs 34 may be coupled to the Internet 22. Like with the MSC 16, the APs can be directly coupled to the Internet. In one embodiment, however, the APs are indirectly coupled to the Internet via a GTW 20. As will be appreciated, by directly or indirectly connecting the terminals and the origin server 23, user processor 24 and/or any of a number of other devices, to the Internet, the terminals can communicate with one another, the user processor, etc., to thereby carry out various functions of the terminal, such as to transmit data, content or the like to, and/or receive content, data or the like from, the user processor. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the terminal 10 to user processors 24 across the Internet 22, the terminal and user processor can be coupled to one another and communicate in accordance with, for example, RF, BT, IrDA or any of a number of different wireline or wireless communication techniques, including LAN and/or WLAN techniques. One or more of the user processors can additionally, or alternatively, include a removable memory capable of storing content, which can thereafter be transferred to the terminal.

Referring now to FIG. 2, a block diagram of an entity capable of operating as a terminal 10, origin server 23 and/or user processor 24, is shown in accordance with one embodiment of the present invention. Although shown as separate entities, in some embodiments, one or more entities may support one or more of a terminal, origin server and/or user processor, logically separated but co-located within the entit(ies). For example, a single entity may support a logically separate, but co-located, terminal and origin server. Also, for example, a single entity may support a logically separate, but co-located terminal and user processor.

As shown, the entity capable of operating as a terminal 10, origin server 23 and/or user processor 24 can generally include a processor 37 connected to a memory 39. The processor can also be connected to at least one interface 41 or other means for transmitting and/or receiving data, content or the like. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention. In addition, when the entity functions as a member of a multicast group of entities, the memory can store a symmetric key associated with the respective entity, as well as a symmetric key associated with each of the other members of the multicast group. In addition, the memory can store a symmetric key common to all members of the multicast group. Further, the memory can store a public/private key pair associated with the respective entity.

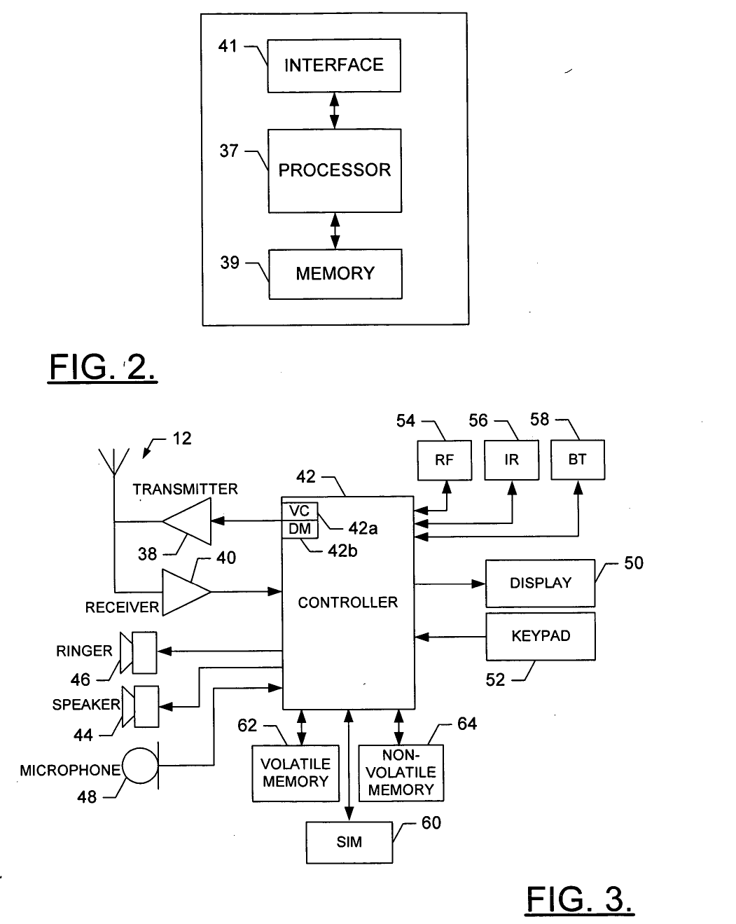

Reference is now made to FIG. 3, which illustrates one type of terminal 10 that would benefit from embodiments of the present invention. It should be understood, however, that the terminal illustrated and hereinafter described is merely illustrative of one type of terminal that would benefit from the present invention and, therefore, should not be taken to limit the scope of the present invention. While several embodiments of the terminal are illustrated and will be hereinafter described for purposes of example, other types of terminals, such as portable digital assistants (PDAs), pagers, laptop computers and other types of electronic systems, can readily employ the present invention.

As shown, in addition to an antenna 12, the terminal 10 can include a transmitter 38, receiver 40, and controller 42 or other processor that provides signals to and receives signals from the transmitter and receiver, respectively. These signals include signaling information in accordance with the air interface standard of the applicable cellular system, and also user speech and/or user generated data. In this regard, the terminal can be capable of operating with one or more air interface standards, communication protocols, modulation types, and access types. More particularly, the terminal can be capable of operating in accordance with any of a number of first generation (1G), second generation (2G), 2.5G and/or third-generation (3G) communication protocols or the like. For example, the terminal may be capable of operating in accordance with 2G wireless communication protocols IS-136 (TDMA), GSM, and IS-95 (CDMA). Also, for example, the terminal may be capable of operating in accordance with 2.5G wireless communication protocols GPRS, Enhanced Data GSM Environment (EDGE), or the like. Further, for example, the terminal may be capable of operating in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 42 includes the circuitry required for implementing the audio and logic functions of the terminal 10. For example, the controller may be comprised of a digital signal processor device, a microprocessor device, and various analog-to-digital converters, digital-to-analog converters, and other support circuits. The control and signal processing functions of the terminal are allocated between these devices according to their respective capabilities. The controller can additionally include an internal voice coder (VC) 42a, and may include an internal data modem (DM) 42b. Further, the controller may include the functionally to operate one or more software programs, which may be stored in memory (described below). For example, the controller may be capable of operating a connectivity program, such as a conventional Web browser. The connectivity program may then allow the terminal to transmit and receive Web content, such as according to HTTP and/or the Wireless Application Protocol (WAP), for example.

The terminal 10 also comprises a user interface including a conventional earphone or speaker 44, a ringer 46, a microphone 48, a display 50, and a user input interface, all of which are coupled to the controller 42. The user input interface, which allows the terminal to receive data, can comprise any of a number of devices allowing the terminal to receive data, such as a keypad 52, a touch display (not shown) or other input device. In embodiments including a keypad, the keypad includes the conventional numeric (0-9) and related keys (#, *), and other keys used for operating the terminal. Although not shown, the terminal can include a battery, such as a vibrating battery pack, for powering the various circuits that are required to operate the terminal, as well as optionally providing mechanical vibration as a detectable output.

The terminal 10 can also include one or more means for sharing and/or obtaining data. For example, the terminal can include a short-range radio frequency (RF) transceiver or interrogator 54 so that data can be shared with and/or obtained from electronic devices in accordance with RF techniques. The terminal can additionally, or alternatively, include other short-range transceivers, such as, for example an infrared (IR) transceiver 56, and/or a Bluetooth (BT) transceiver 58 operating using Bluetooth brand wireless technology developed by the Bluetooth Special Interest Group. The terminal can therefore additionally or alternatively be capable of transmitting data to and/or receiving data from electronic devices in accordance with such techniques. Although not shown, the terminal can additionally or alternatively be capable of transmitting and/or receiving data from electronic devices according to a number of different wireless networking techniques, including WLAN techniques such as IEEE 802.11 techniques or the like.

The terminal 10 can further include memory, such as a subscriber identity module (SIM) 60, a removable user identity module (R-UIM) or the like, which typically stores information elements related to a mobile subscriber. In addition to the SIM, the terminal can include other removable and/or fixed memory. In this regard, the terminal can include volatile memory 62, such as volatile Random Access Memory (RAM) including a cache area for the temporary storage of data. The terminal can also include other non-volatile memory 64, which can be embedded and/or may be removable. The non-volatile memory can additionally or alternatively comprise an EEPROM, flash memory or the like. The memories can store any of a number of software applications, instructions, pieces of information, and data, used by the terminal to implement the functions of the terminal. For example, the memories can store an identifier, such as an international mobile equipment identification (IMEI) code, international mobile subscriber identification (IMSI) code, mobile station integrated services digital network (MSISDN) code (mobile telephone number), Internet Protocol (IP) address, Session Initiation Protocol (SIP) address or the like, capable of uniquely identifying the terminal, such as to the MSC 16.

As explained in the background section, a typical goal in security for multicast communication is to provide data source authentication, often in addition to securing (encrypting) multicast communication for the multicast group. And where as conventional techniques such as digital signatures have been utilized to provide some measure of data source authentication, such techniques can be significantly slower to implement than symmetric key cryptography message authentication codes (MACs), and can require more data space overhead than MACs. Even other conventional techniques, such as star/tree hashing and different variations of hash chaining, while reducing the overhead associated with digital signatures, typically increase the communication costs, and often require the source and destinations to buffer data. In addition, various techniques such as that provided by the TESLA protocol can require a form of time synchronization between the source and destinations, further complicating the authentication procedure.

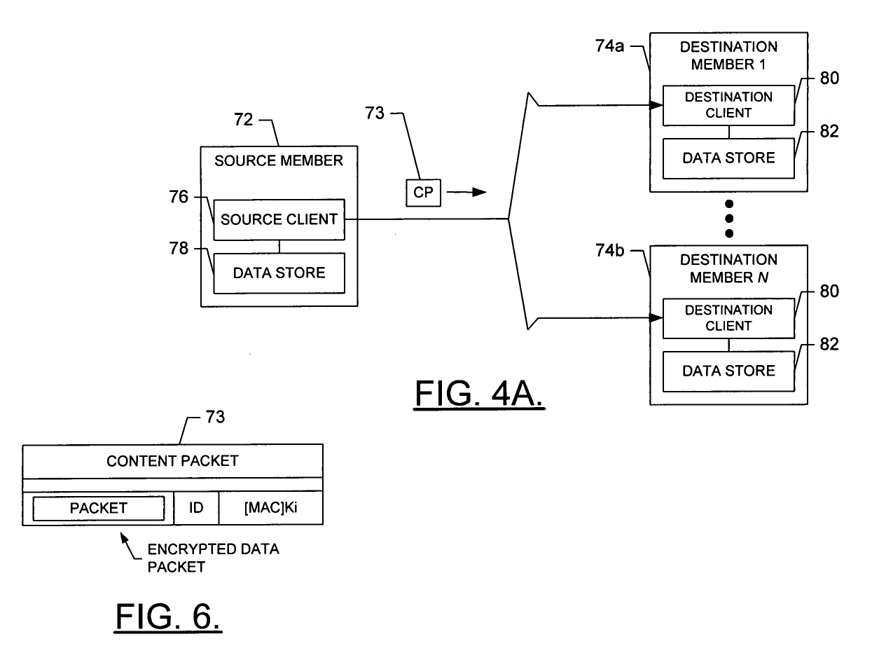

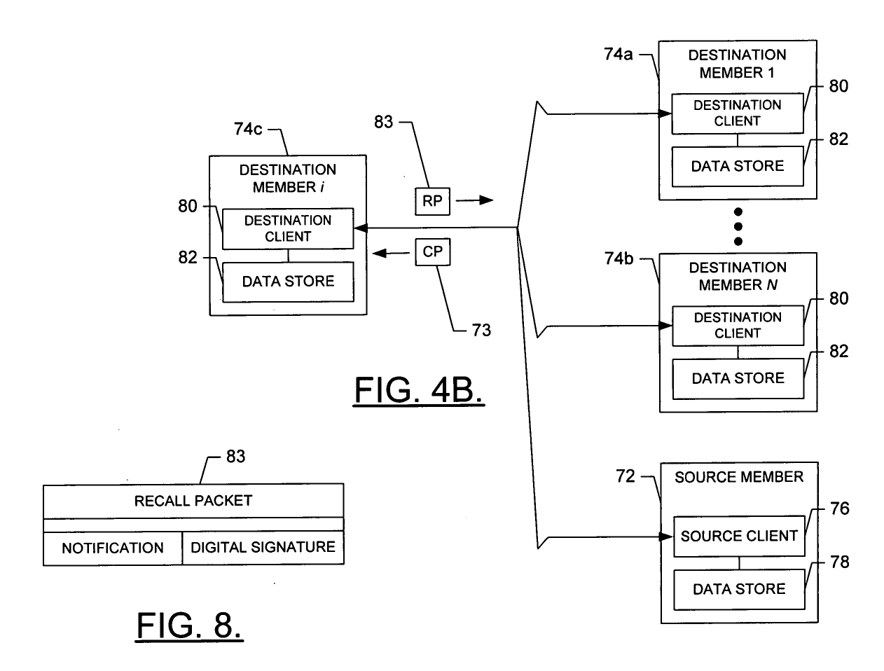

Reference is now drawn to FIGS. 4A and.4B, which illustrate functional block diagrams and a flowchart, respectively, of a source member 72 of a multicast group sending, multicasting or otherwise transferring one or more content packets (CP) 73 each including one or more data packets, to a plurality of destination members 74 of the multicast group (i.e., N destination members), two destination members 74a and 74b being shown. As shown, the source member is capable of operating an application, such as a source client 76, which is capable of multicasting one or more data packets from a data store 78 in memory (e.g., memory 39) of the source, to the destination members. The destination members, in turn, are each capable of operating a destination client 80, which is capable of receiving the content packets and authenticating the source member based upon information in the content packets. Thereafter, if the source member is authenticated, the destination agents can be capable of storing the data packet(s) in a content storage 82 associated with the respective destination members.

As explained in greater detail below, in accordance with embodiments of the present invention, the destination clients 80 of the destination members 74 are capable of authenticating the source member 72 without requiring digital signatures or time synchronization between the source and destinations in point-to-multipoint, multicast communication. Briefly, as explained below, each member of a multicast group can be associated with a symmetric key that is known to each other member of the multicast group. To permit the source member to multicast data packets to the destination members, and allow the destination members to authenticate the source member of the data packets, the source client 76 of the source member can generate a content packet 73 based upon a symmetric key associated with the source member, the content packet including the data packet. More particularly, the source client can generate a content packet including the data packet, the identity of the source member and a code generated with the symmetric key associated with the source member. And if so desired, the source client can encrypt the data packet and/or source member ID with its symmetric key or a group symmetric key.

The destination clients 80 of the destination members 74 can then authenticate the source member 72 based upon the content packet and the symmetric key associated with the source member. More particularly the destination clients can authenticate the source member by decrypting and authenticating the code with the symmetric key of the source member. Then, if the identity of the source member is authenticated, the destination clients can decrypt the data packet with the source symmetric key or group symmetric key (which ever used to encrypt the data packet), and thereafter store the decrypted data packets in data stores 82. By utilizing symmetric key associated with the source member, and authenticating the source member based upon its symmetric key, the destination clients of embodiments of the present invention are capable of authenticating the source member against communications outside the multicast group.

As will be appreciated, however, since every member of the multicast group knows the symmetric key of every other member of the group, one member of the group can be capable of multicasting data packets using the symmetric key and identity of another member of the group, thus spoofing or claiming the identity of another member of the group. As such, to deter one member of the group from spoofing the identity of another member, each member of the multicast group can be configured to multicast a “recall” packet (RP) 83 to the multicast group when the member receives a data packet purported to be from itself, which the member did not multicast to the group, as shown in FIG. 4B. Then, the destination clients 80 of the destination members 74 that received the content packet from the spoofing member can also receive the recall packet and determine, from the recall packet, that the previously received content packet was not, in fact, sent from the member identified by the content packet. The destination clients can thereafter treat the previously received content packet as though the source member that multicasted the content packet (i.e., the spoofing group member) were not authenticated.

As shown and described herein, the source client 76 and destination client 80 each comprise software operated by the source member 72 and destination member 74, respectively. It should be understood, however, that the source client and/or destination client can alternatively comprise firmware or hardware, without departing from the spirit and scope of the present invention. Also, although the source client and destination client are shown and described as being local to the source member and destination member, respectively, any one or more of the source client and destination client can alternatively be distributed from, and in communication with, the source and destination, respectively, such as across the Internet 22. Further, as shown and described herein, content packets are sent or otherwise transferred from a source member to destination members. It should be understood, however, that the terms “sending,” “multicasting” and “transferring” can be used herein interchangeably, and that sending, multicasting or transferring data packets can include, for example, moving or copying content from the source member to the destination members, without departing from the spirit and scope of the present invention.

The system, method and computer program product of embodiments of the present invention will now be described in more detail with respect to a source member 72 sending, multicasting or otherwise transferring one or more data packets to a plurality of destination members 74. As described herein, the source and destination members are members of a multicast group and can each comprise any entity (e.g., terminal 10, origin server 23, user processor 24, etc.) capable of multicasting and/or receiving data packets, content or the like in accordance with any of a number of different multicast communication techniques. Within a multicast group, a source member can comprise any group member functioning in accordance with embodiments of the present invention to multicast one or more data packets to a plurality of destination members. The destination members, on the other hand, can comprise any group members functioning in accordance with embodiments of the present invention to receive data packets from the source member and thereafter authenticate the source member. As will be further appreciated, although functionally operating in different manners, the same entity can, at different times, function as a source member, destination member or both a source member and a destination member.

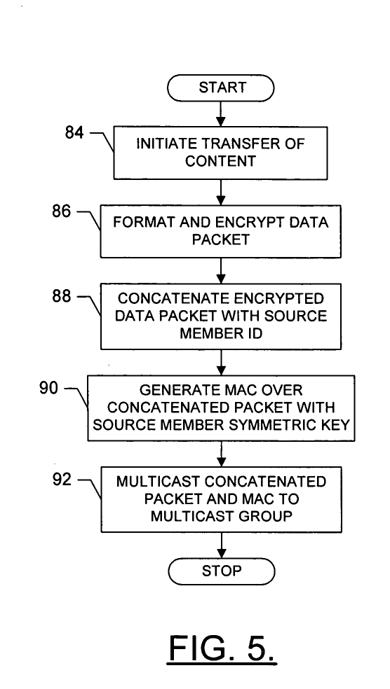

Reference is now drawn to FIG. 5, which illustrates a flowchart including various steps in a method of multicasting one or more data packets to a multicast group, in accordance with one embodiment of the present invention. As shown in block 84, the method can include initiating the source client 76 of a source member 72 to transfer one or more pieces of content. After initiating the source client 78, the source client can format the content into one or more data packets. For example, the source client can format the content into an Ethernet frame, an Internet Protocol (IP) packet, a segment, a datagram or the like. Then, the source client can, but need not, encrypt the data packet, as shown in block 86. The source client can encrypt the data packet in accordance with any of a number of different techniques. In one embodiment, for example, the source client can encrypt the data packet in accordance with a multicast encapsulating security payload (MESP) technique. In this regard, in accordance with one embodiment, the source client can encrypt the data packet with a group symmetric key known to each member of the multicast group. The group key can comprise any of a number of different symmetric keys such as, for example, a group traffic encryption key (GTEK).

After encrypting the data packet, the source client 76 of the source member 72 can add or otherwise concatenate the encrypted data packet with an identifier (ID) capable of identifying the source member to other members of the multicast group, as shown in block 88. In this regard, each member of the multicast group can be associated with any of a number of different identifiers capable of identifying the member to other members of the group. For example, when the multicast members comprise mobile terminals 10, the member identifiers can comprise IMEI codes, IMSI codes, MSISDN codes, IP addresses, SIP addresses or the like.

Irrespective of the member identifier concatenated with the encrypted data packet, the source client 76 of the source member 76 can thereafter generate a code using the concatenated packet and a symmetric key associated with the source member, as shown in block 90. As indicated above, each member of the multicast group can be associated with a symmetric key that is known to each other member of the multicast group. Thus, destination members can thereafter authenticate the source member based upon the code and the symmetric key associated with the source member. The symmetric keys can be generated and provided to the multicast group members in any of a number of different manners. For example, the symmetric keys can be generated from the same or different keying material, which may include an identifier or index of each member of the multicast group. The symmetric keys can then be provided to the multicast group, such as by a key generator (not shown) in accordance with the Diffie-Hellman key agreement protocol, as such is well known to those skilled in the art.

The code generated by the source client 76 of the source member 76 can comprise any of a number of different codes. In one typical embodiment, for example, the code comprises a message authentication code (MAC). The MAC can comprise, for example, a cryptographic checksum of the concatenated packet generated using the source member symmetric key. Alternatively, for example, the MAC can comprise a cryptographic checksum of a hash of the concatenated packet generated using the source member symmetric key. In such instances, although not shown, the concatenated packet can be hashed before generating the MAC such that the MAC is smaller than if generated without hashing the concatenated packet. Irrespective of how the source client generates the MAC, however, the source client can thereafter multicast a content packet 73 to a plurality of destination members 74 of the multicast group including the source member, the content packet 73 including the concatenated packet and MAC (generated with the source member symmetric key), as shown in block 92. For an illustration of an exemplar content packet, see FIG. 6 (Ki representing the source member symmetric key used to generate the MAC).

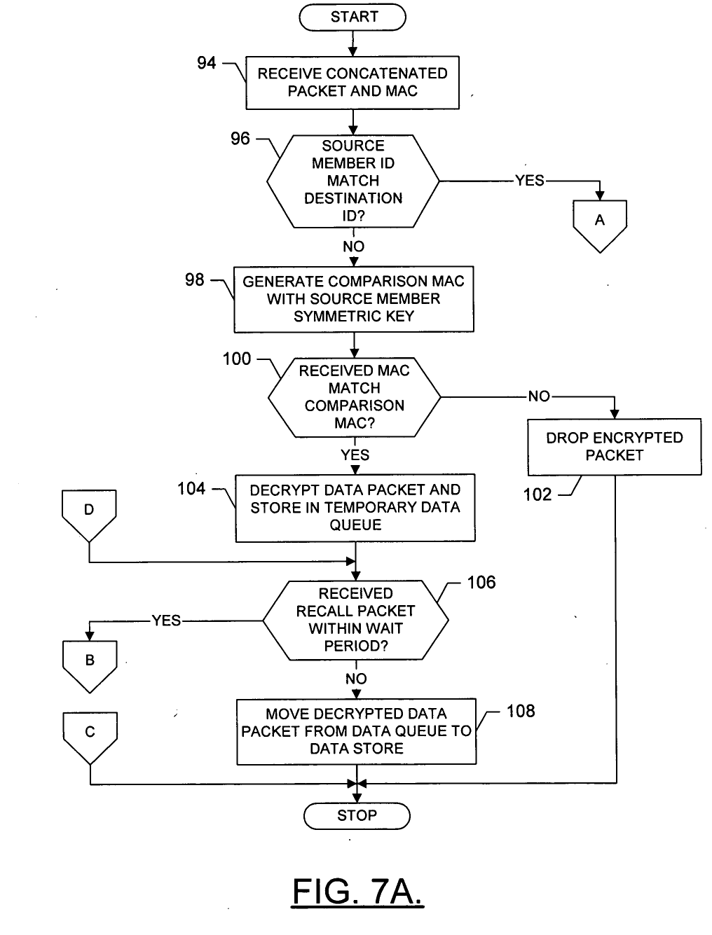

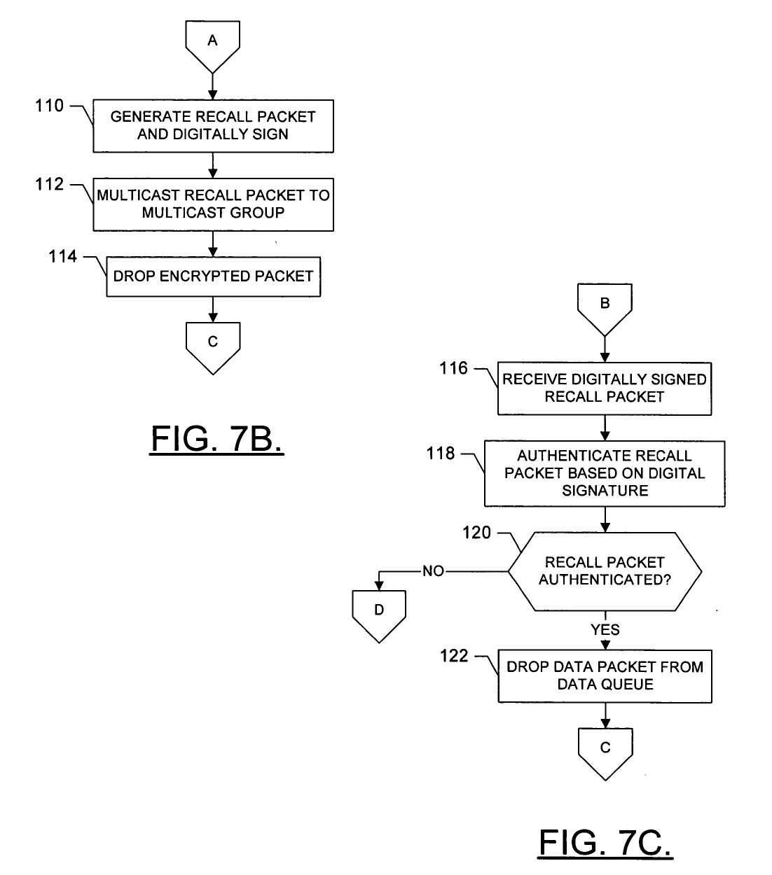

Referring now to FIGS. 7A, 7B and 7C, a method of authenticating a source member 72 multicasting data packets to a multicast group including the source member and a plurality of destination members 74 is provided. As shown, the method includes each destination member receiving a content packet 73 including a concatenated packet comprising an encrypted data packet and source member identifier, and a MAC, as shown in block 94. Thereafter, each destination member, or more particularly each destination client 80 of each destination member, can determine if the content packet originated from a group member spoofing or claiming the identity of the respective destination member based upon the source member identifier. More particularly, the destination client can determine if the source member identifier in the content packet matches the destination member identifier of the respective destination member (instead of the source member that actually sent the content packet), as shown in block 96.

If the destination client 80 of the destination member 74 identifies a match between the source member identifier and the member identifier of the respective destination member, the destination client is capable of generating and multicasting a recall packet (RP) 83 to notify the members of the multicast group that the source member 72 spoofed the identity of the respective destination member, as shown in FIG. 4B and block 110 of FIG. 7B. In other terms, the destination client is capable of generating a recall packet to notify the members of the multicast group that the member identifier in the content packet is not associated with the source member that sent the content packet, but rather the destination member multicasting the recall packet.

The recall packet can include any of a number of different pieces of information such as, for example, a notification to the members of the multicast group. To decrease the likelihood of a destination member 74 successfully multicasting a recall packet in response to a content packet 73 properly sent from a source member 72, the destination client 80 of the respective destination member can digitally sign the recall packet, such as with a private key of a public/private key pair associated with the destination member, as also shown in block 110. In this regard, each member of the multicast group can also be associated with a public/private key pair, with the public key of the pair known to the other members of the multicast group. For an example of a digitally signed recall packet, see FIG. 8.

After digitally signing the recall packet, the respective destination client 80 can multicast the digitally signed recall packet to the multicast group, including the other destination members 74 and the source member 72 originally multicasting the content packet 73 (now a destination member with respect to the recall packet), as shown in block 112. Also after identifying a match between the source member identifier and the respective destination member identifier, typically after multicasting the recall packet, the destination client can drop the encrypted packet since the destination client failed to authenticate the source member, as shown in block 114.

If the destination client 80 of the destination member 74 does not identify a match between the source member identifier and the destination member identifier, the destination client can generate a comparison MAC using the symmetric key associated with the source member identifier, such as in the same manner the source client 76 of the source member 72 generated the MAC included within the content packet 73, as shown in block 98 of FIG. 7A. More particularly, for example, the destination client can generate the comparison MAC using the concatenated packet and the symmetric key associated with the source member. In this regard, the symmetric key associated with the source member can be selected based upon the source member identifier, such as when the destination member stores the symmetric keys for the group members indexed by the group member identifiers. Alternatively, when the source client hashes the concatenated packet before generating the MAC, the destination client can hash the concatenated packet before generating the MAC, and thereafter generate the MAC from the hash.

As shown in block 100 after generating the comparison MAC, the destination client 80 of the destination member 74 can compare the comparison MAC with the MAC in the content packet 73. If the destination client does not identify a match, the source member is not authenticated. In such instances, the destination client can drop the encrypted packet, and if so desired, can inform the source member that the destination failed to authenticate the source member, as shown in block 102. On the other hand, if the destination client does identify a match, the source member is authenticated, and the destination client can decrypt the data packet, such as in opposite manner that the source member encrypted the data packet (e.g., group symmetric key or source member symmetric key), as shown in block 104.

After decrypting the data packet, the destination client 80 of the destination member 74 can store the decrypted data packet in a temporary data queue within the data store 82 of the destination, as also shown in block 104. The destination client can then maintain the decrypted data packet in the data queue for a wait period to allow another destination client, to determine a match between the source member identifier and the respective destination member identifier, and if a match is identified, to multicast a digitally signed recall packet to the multicast group including the destination of the respective destination client, as explained above (see blocks 96 and 110-114). If the destination client does not receive a recall packet within the wait period, the destination client can move the decrypted data packet from the data queue to another, more permanent location in the data store of the destination, as shown in blocks 106 and 108.

If the destination client 80 of the destination member 74 does receive a recall packet within the wait period, however, the destination client can thereafter attempt to authenticate the digitally signed recall packet based on the digital signature, as shown in blocks 116 and 118 of FIG. 7C. In this regard, the destination client can authenticate the recall packet using the public key of the private/public key pair associated with the destination client multicasting the recall packet (now a source member with respect to the recall packet). If the recall packet is authenticated, the destination client can interpret the recall packet notification, and recognizing that the decrypted data packet did not originate with the source member identified in the content packet 73, drop the decrypted data packet from the data queue within the data store 82 of the destination member, as shown in blocks 120 and 122. If the recall packet is not authenticated, however, the destination client can continue to maintain the decrypted data packet in the data queue for a wait period (see block 106), moving the decrypted data packet if the destination client does not receive and authenticate a recall packet within the wait period (see block 108).

Therefore, in accordance with embodiments of the present invention, members of a multicast group are capable of multicasting data packets to other members of the group. Before multicasting a data packet, however, the member multicasting the data packet (i.e., the source member 72) can generate a MAC using a symmetric key associated with the source member and known to the other members of the multicast group. Then, the source member can multicast the data packet and the MAC to the other members of the group (i.e., the destination members 74). The other members of the group can receive the multicast data packet and MAC can thereafter authenticate the source member based upon the MAC and the symmetric key associated with the source member. Further, to deter one member of the group from spoofing the identity of another member by multicasting a MAC generated with the symmetric key associated with another member, each member of the multicast group can be configured to multicast a “recall” packet (RP) 83 to the multicast group when the member receives a data packet purported to be from itself, which the member did not multicast to the group. Then, the destination members that received the data packet from the spoofing member can also receive the recall packet and determine, from the recall packet, that the previously received data packet was not, in fact, sent from the member identified by the data packet. The destination clients can thereafter treat the previously received data packet as though the source member multicasting the data packet (i.e., the spoofing group member) were not authenticated.

As described above, the source client 76 of the source member 72 can add or otherwise concatenate the data packet (encrypted or otherwise) with an identifier (ID) associated with the source member. The destination members can then utilize the source member identifier to determine if the source member is spoofing the identity of the respective destination members, and to select the symmetric key associated with the source member and authenticate the source member based upon the respective symmetric key (i.e., by generating a comparison MAC using the respective symmetric key). It should be noted, however, that the source client need not add or concatenate the source member identifier to the data packet. In such an instance, the destination members can determine the source member identifier by generating and comparing a comparison MAC based upon the symmetric key associated with each other member of the multicast group until a comparison MAC matches the MAC of the content packet. Each destination member can also determine if the source member is spoofing the identity of the destination member by generating a comparison MAC based upon the destination member symmetric key, and comparing the comparison MAC to the MAC of the content packet. If the destination member identifies a match, the source member spoofed the identity of the destination member.

As also described above, the source client 76 of the source member 72 can generate a content packet by encrypting a data packet, concatenating the data packet to the source member identifier, hashing the concatenated packet, and generating a MAC based upon the hashed, concatenated packet based upon the source member identifier. It should also be understood that the steps of generating the content packet can occur in one or more alternative orders, if so desired. For example, the source client can generate a content packet by hashing a data packet, concatenating the hashed data packet with the source member identifier, and generating a MAC based upon the concatenated packet based upon the source member identifier. In either event, however, the source client can, but need not, hash the concatenated packet or data packet.

According to one aspect of the present invention, all or a portion of the system of the present invention, such all or portions of the source member 72 and/or destination members 74, generally operate under control of a computer program product (e.g., source client 76, destination clients 80, etc.). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 5, 7A, 7B and 7C are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create, means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for multicasting a data packet in a multicast group, the system comprising:
a source member capable of generating a code for the data packet using a symmetric key associated with the source member, wherein the source member is capable of multicasting the data packet and the code; and
a plurality of destination members capable of receiving the data packet and the code, wherein each destination member is capable of multicasting a recall packet to the members of the multicast group when the destination member determines that the source member claims an identity of the respective destination member, and wherein the destination member is otherwise capable of authenticating the source member based upon the code.

2. A system according to claim 1, wherein each destination member is capable of multicasting the recall packet by digitally signing a recall packet using a private key of a public/private key pair associated with the destination member, and thereafter multicasting the digitally signed recall packet such that the members of the multicast group can authenticate the recall packet using the public key of the public/private key pair.

3. A system according to claim 1, wherein the source member is capable of multicasting a content packet comprising the data packet, the code and a member identifier, and wherein each destination member is capable of comparing the member identifier in the content packet to a member identifier associated with the destination member, and thereafter multicasting the recall packet to the multicast group when the comparison identifies a match between the member identifier in the content packet to the member identifier associated with the destination member.

4. A system according to claim 1, wherein each destination member is capable of authenticating the source member by authenticating the code using the data packet and the symmetric key associated with the source member.

5. A system according to claim 4, wherein the source member is capable of generating a message authentication code (MAC) using the data packet and the symmetric key associated with the source member, and wherein each destination member is capable of authenticating the code by generating a comparison MAC at the destination member based upon the data packet and the symmetric key associated with the source member, and thereafter comparing the comparison MAC with the received MAC such that the source member is authenticated when the comparison identifies a match between the comparison MAC and the received MAC.

6. A system according to claim 1, wherein each destination member is further capable of storing the data packet in a temporary data queue of a data store for a wait period if the source member is authenticated, and wherein each destination member is capable of dropping the data packet from the data queue if a recall packet is received within the wait period, and otherwise, moving the data packet from the temporary data queue after the wait period.

7. A system according to claim 1, wherein the source member is capable of encrypting the data packet and thereafter multicasting the encrypted data packet, and wherein each destination member is capable of decrypting the encrypted data packet if the source member is authenticated.

8. A destination member for receiving a data packet in a multicast group including a plurality of members, the data packet being multicast from a source member, wherein the destination member comprises:
a processor capable of operating a destination client, wherein the destination client is capable of receiving the data packet and a code for the data packet, the code having been generated at the source member using a symmetric key associated with the source member, wherein the destination client is also capable of multicasting a recall packet to the members of the multicast group when the destination client determines that the source member claims an identity of the destination member, and otherwise, authenticating the source member based upon the code.

9. A destination member according to claim 8, wherein the destination client is capable of digitally signing a recall packet using a private key of a public/private key pair associated with the destination member, and thereafter multicasting the digitally signed recall packet such that the members of the multicast group can authenticate the recall packet using the public key of the public/private key pair.

10. A destination member according to claim 8, wherein the destination client is capable of receiving a content packet comprising the data packet, the code and a member identifier, and wherein the destination client is capable of comparing the member identifier in the content packet to a member identifier associated with the destination member, and multicasting the recall packet to the multicast group when the comparison identifies a match between the member identifier in the content packet to the member identifier associated with the destination member.

11. A destination member according to claim 8, wherein the destination client is capable of authenticating the source member by authenticating the code using the data packet and the symmetric key associated with the source member.

12. A destination member according to claim 11, wherein the destination client is capable of receiving a code for the data packet comprising a message authentication code (MAC) for the data packet, the MAC having been generated at the source member using the data packet and the symmetric key associated with the source member, and wherein the destination client is capable of authenticating the code by generating a comparison MAC at the destination member based upon the data packet and the symmetric key associated with the source member, and thereafter comparing the comparison MAC with the received MAC such that the source member is authenticated when the comparison identifies a match between the comparison MAC and the received MAC.

13. A destination member according to claim 8 further comprising:
a data store including a temporary data queue,
wherein the destination client is capable of storing the data packet in the data queue for a wait period if the source member is authenticated, wherein the destination client is also capable of dropping the data packet from the data queue if a recall packet is received within the wait period, and otherwise, moving the data packet from the data queue after the wait period.

14. A destination member according to claim 8, wherein the destination client is capable of receiving an encrypted data packet, the data packet having been encrypted by the source member, and wherein the destination client is capable of decrypting the encrypted data packet if the source member is authenticated.

15. A method of authenticating a source member of a multicast group including a plurality of members, the source member having multicast a data packet to a plurality of destination members, wherein, for at least one destination member, the method comprises:
receiving the data packet and a code for the data packet at the destination member, the code having been generated at the source member using a symmetric key associated with the source member;
multicasting a recall packet from the destination member to the members of the multicast group when the destination member determines that the source member claims an identity of the destination member; and otherwise,
authenticating the source member at the destination member based upon the code.

16. A method according to claim 15, wherein multicasting a recall packet comprises:
digitally signing a recall packet using a private key of a public/private key pair associated with the destination member; and
multicasting the digitally signed recall packet such that the members of the multicast group can authenticate the recall packet using the public key of the public/private key pair.

17. A method according to claim 15, wherein receiving the data packet and a code for the data packet comprises receiving a content packet comprising the data packet, the code and a member identifier, and wherein multicasting a recall packet comprises:
comparing the member identifier in the content packet to a member identifier associated with the destination member; and
multicasting a recall packet to the multicast group when the comparison identifies a match between the member identifier in the content packet to the member identifier associated with the destination member.

18. A method according to claim 15, wherein authenticating the source member comprises authenticating the code using the data packet and the symmetric key associated with the source member.

19. A method according to claim 18, wherein receiving a code for the data packet comprises receiving a message authentication code (MAC) for the data packet, the MAC having been generated at the source member using the data packet and the symmetric key associated with the source member, and wherein authenticating the code comprises:
generating a comparison MAC at the destination member based upon the data packet and the symmetric key associated with the source member; and
comparing the comparison MAC with the received MAC such that the source member is authenticated when the comparison identifies a match between the comparison MAC and the received MAC.

20. A method according to claim 15 further comprising:
storing the data packet in a temporary data queue of a data store for a wait period if the source member is authenticated;
dropping the data packet from the data queue if a recall packet is received within the wait period; and otherwise,
moving the data packet from the temporary data queue after the wait period.

21. A method according to claim 15, wherein receiving the data packet comprises receiving an encrypted data packet, the data packet having been encrypted by the source member, and wherein the method further comprises:
decrypting the encrypted data packet if the source member is authenticated.

22. A computer program product for authenticating a source member of a multicast group including a plurality of members, the source member having multicast a data packet to a plurality of destination members, wherein the computer program product is adapted to be embodied within at least one destination member, and wherein the computer program product comprises at least one computer-readable storage medium having computer-readable program code portions stored therein, the computer-readable program code portions comprising:
a first executable portion for receiving the data packet and a code for the data packet, the code having been generated at the source member using a symmetric key associated with the source member;
a second executable portion for multicasting a recall packet to the members of the multicast group when the destination member determines that the source member claims an identity of the destination member; and
a third executable portion for authenticating the source member when the destination member determines that the source member does not claim an identity of the destination member, the third executable portion authenticating the source member based upon the code.

23. A computer program product according to claim 22, wherein the second executable portion is adapted to digitally sign a recall packet using a private key of a public/private key pair associated with the destination member, and thereafter multicast the digitally signed recall packet such that the members of the multicast group can authenticate the recall packet using the public key of the public/private key pair.

24. A computer program product according to claim 22, wherein the first executable portion is adapted to receive a content packet comprising the data packet, the code and a member identifier, and wherein the second executable portion is adapted to compare the member identifier in the content packet to a member identifier associated with the destination member, and thereafter multicast the recall packet to the multicast group when the comparison identifies a match between the member identifier in the content packet to the member identifier associated with the destination member.

25. A computer program product according to claim 22, wherein the third executable portion is adapted to authenticate the source member by authenticating the code using the data packet and the symmetric key associated with the source member.

26. A computer program product according to claim 25, wherein the first executable portion is adapted to receive a code comprising a message authentication code (MAC) for the data packet, the MAC having been generated at the source member using the data packet and the symmetric key associated with the source member, and the third executable portion is adapted to authenticate the code by generating a comparison MAC at the destination member based upon the data packet and the symmetric key associated with the source member, and thereafter comparing the comparison MAC with the received MAC such that the source member is authenticated when the comparison identifies a match between the comparison MAC and the received MAC.

27. A computer program product according to claim 22 further comprising:
a fourth executable portion for storing the data packet in a temporary data queue of a data store for a wait period if the source member is authenticated;
a fifth executable portion for dropping the data packet from the data queue if a recall packet is received within the wait period; and
a sixth executable portion for moving the data packet from the temporary data queue after the wait period if a recall packet is not received within the wait period.

28. A computer program product according to claim 22, wherein the first executable portion is adapted to receive an encrypted data packet, the data packet having been encrypted by the source member, and wherein the computer program product further comprises:
a fourth executable portion for decrypting the encrypted data packet if the source member is authenticated.
